(19) United States
(12) Patent Application Publication
(10) Pub. No.: US 2011/0176898 A1
(43) Pub. Date: Jul. 21, 2011

(54) SHIPPING CONTAINER LIFTING AND MANEUVERING DOLLY

(75) Inventors: J. Dexter Bird, III, Hampton, VA (US); Michael J. Plackett, Corvalis, OR (US); Frank A. Leban, Columbia, MD (US)

(73) Assignee: United States of America as represented by the Secretary of the Navy, Arlington, VA (US)

(21) Appl. No.: 12/905,114

(22) Filed: Oct. 15, 2010

Related U.S. Application Data
(60) Provisional application No. 61/296,894, filed on Jan. 21, 2010.

(51) Int. Cl. B60P 1/00

(52) U.S. Cl. 414/540

(57) ABSTRACT

A dolly is particularly adapted to lift, support and maneuver a 20-foot shipping container. A shipping container support frame also supports a shipping container capture assembly. The capture assembly includes a pair of parallel, opposing shipping container capture slides. A pair of hydraulic jacks is attached to each capture slide. The jacks move shipping container engagements pins vertically. The slides move the shipping container laterally and the jacks move it vertically to pick it up and allow the support frame to move under the container. The support frame has steerable wheels for movement. Counterweights or auxiliary container stabilizers are unnecessary.

### CROSS-REFERENCE TO RELATED APPLICATION

This application claims priority from U.S. Provisional Patent Application No. 61/296,894 filed Jan. 21, 2010, for a Shipping Container Lifting and Maneuvering Dolly, the disclosure of which is incorporated herein by reference in its entirety.

### STATEMENT OF GOVERNMENT INTEREST

The invention described herein may be manufactured and used by or for the Government of the United States of America for governmental purposes without the payment of any royalties thereon or therefor.

### BACKGROUND OF THE INVENTION

1. Field of the Invention

The invention relates to article handling. The invention also relates to self-loading and unloading land vehicles. More particularly, the invention relates to a dolly for lifting, supporting and maneuvering a shipping container.

2. Discussion of the Related Art

A substantial portion of ship cargo is carried in shipping containers. Exceptions include dry-bulk cargo, petroleum, petroleum base liquids, chemical liquids and motor vehicles. The rest of ship cargo is carried in shipping containers.

Shipping containers are manufactured in a limited number of standard sizes to facilitate transfer to and stowage on oceangoing ships, barges, rail cars and truck trailers. Transfer is carried out by means of cranes with sufficient capacity for the load. The shipping containers are fitted with integral structural lifting points. A crane engages lifting points from above to make the transfer. An empty container can be moved by means of a fork lift. However, a loaded container may weigh up to 30 tons and may not be able to be lifted using the container's fork lift slots because of structural limitations in a frame with slots.

Shipping containers are commercially available in standard sizes including 20-foot, 40-foot, 45-foot, 48-foot and 53-foot lengths. A standard cross-section dimension is 8 feet by 8 feet. The 9.5-foot high cube and 4.25-foot half height are also used. Eyelets are provided for lifting points at the top and bottom of the frame.

Rapid deployment of military equipment is facilitated by the effective use of shipping containers. Containers may be shipped to locations that are not fully prepared for their receipt. Fully functional wharf facilities with container cranes may not be available. Also, ships that are not specifically designed for loading containers may be called into service. Containers may be stowed below deck where there is limited access to an overhead crane. In addition, containers may be used on land for storage and there may not be a crane available at a temporary storage facility. Rapid deployment of military equipment can be limited by the speed at which containers can be loaded and stowed below deck and later unloaded from a ship. Rapid deployment may also be limited by the ability to move and maneuver containers on land.

There is a need in the art of transferring shipping containers for an improvement in loading, unloading and maneuvering apparatus.

### SUMMARY OF THE INVENTION

The invention is a dolly particularly adapted for lifting and maneuvering a shipping container. The dolly comprises a shipping container capture assembly with supporting attachment to a primary rigid support frame.

The primary rigid support frame supports and maneuvers a shipping container. For this maneuvering function it has surface propulsion means. A secondary rigid support member connects it to the shipping container capture assembly.

The shipping container capture assembly comprises a pair of parallel, opposing shipping container capture slides. Each slide includes a generally horizontally elongated rail and a sliding member horizontally moveable on the rail and extendable therefrom. The sliding member has an attachment surface, facing an opposing slide member. A horizontally acting first hydraulic jack assembly connects the two opposing shipping container capture slides and is positioned to draw the slides reciprocally together to capture a shipping container. A second hydraulic jack assembly moves the sliding member horizontally on the rail.

A third hydraulic jack assembly has a body attached to the attachment surface. The third hydraulic jack assembly has a jack rod to which is attached an engagement pin assembly. The engagement pin assembly is moved vertically by the jack rod between a lower position and an upper position. Magnitude of the length between the lower position and upper position is only the vertical length necessary to allow primary support frame 50 and propulsion means 55 to move under a lifted container. That is, the vertical height of the primary support frame 50 and propulsion means 55 together. Advantageously, this arrangement allows a function that avoids the need for counterweights or auxiliary stabilizers.

The engagement pin assembly has an engagement pin moveable horizontally between a shipping container lifting point engaged position and a disengaged position.

The capture assembly positions relative to a shipping container so that the slide assembly and engagement pin assembly insert lifting pins in eyelets in the shipping container. The shipping container is lifted and maneuver, supported by the primary support frame, secondary support member and capture assembly.

### BRIEF DESCRIPTION OF THE DRAWINGS

FIG. 1 is a perspective view of a shipping container.

FIG. 2 is a perspective view of a dolly together with a shipping container.

FIG. 3 is a side view of a dolly with sliding members extended and attached to a shipping container, before lifting and supported on a surface. FIG. 3A is a sectional view of FIG. 3 taken along line 3A-3A.

FIG. 4 is a side view of a dolly with sliding members extended and attached to a shipping container in the lifted position.

FIG. 5 is a side view of a dolly with sliding members retracted and the primary support frame under and supporting a shipping container.

FIG. 6A is a side view of the vertically acting third hydraulic jack assembly shown in FIG. 3 taken along line 6A-6A.

FIG. 6B is a side view of the vertically acting third hydraulic jack assembly shown in FIG. 6A with internal members exposed.

### DETAILED DESCRIPTION OF THE INVENTION

The invention is described with reference to the drawing wherein numerals in the written description correspond to like-numbered elements in the several figures. The drawing discloses a preferred embodiment of the invention and is not intended to limit the generally broad scope of the invention as set forth in the claims.

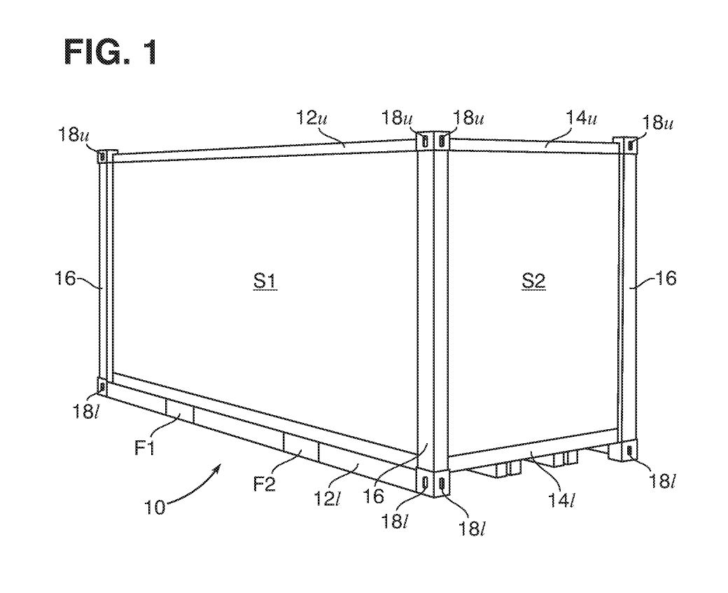

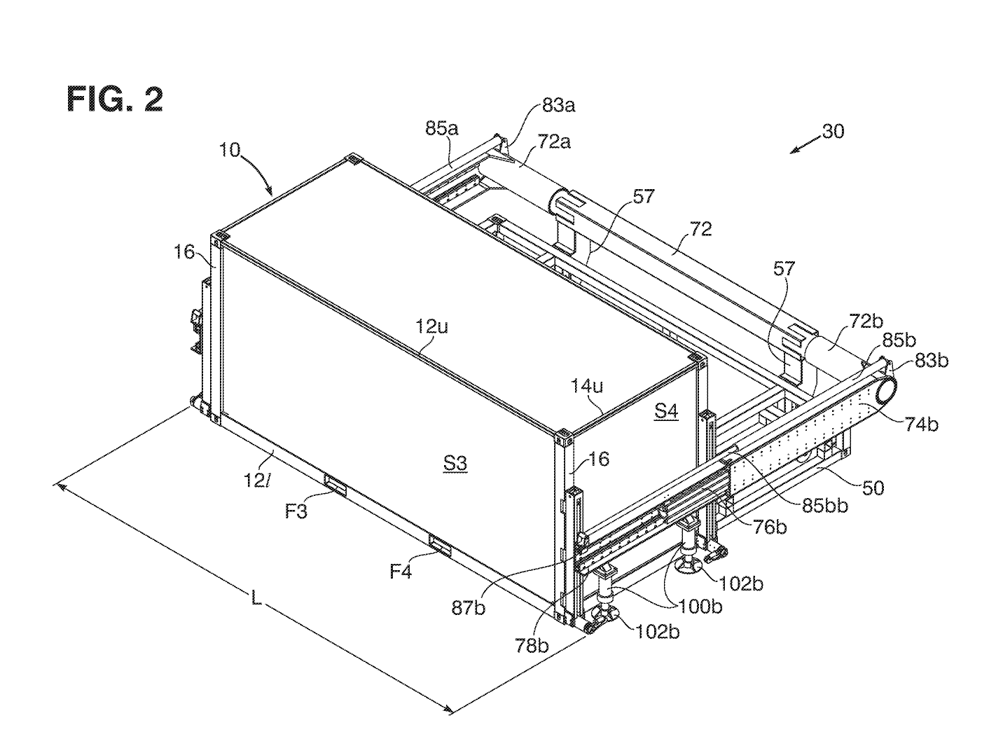

Reference is made to FIG. 1 and FIG. 2 showing a shipping container 10 including sides S1 and S2 seen in FIG. 1 and sides S3 and S4 shown in FIG. 2. Shipping container 10 includes a container frame that maintains the three dimensional shape of the container when fully loaded and lifted. The container frame includes a pair of lower elongated members 12 l, a pair of upper elongated members 12 u, a pair of lower end members 14 l, a pair of upper end members 14 u and four vertical members 16. In each of the pairs, one of the members is out of view. Shipping container 10 has lower lifting eyes 18 l and upper lifting eyes 18 u. The lifting eyes are structural lifting points in the container frame for attaching a lifting means. Lifting eyes are reinforced to maintain their shape and integrity. An empty container may be lifted with a fork lift. Slots are provided in the frame for inserting forks. Slots F1 and F2 are seen in FIG. 1 and slots F3 and F4 are seen in FIG. 2. However, a survey has shown that the slot spacing is not uniform and not all containers have fork lift slots.

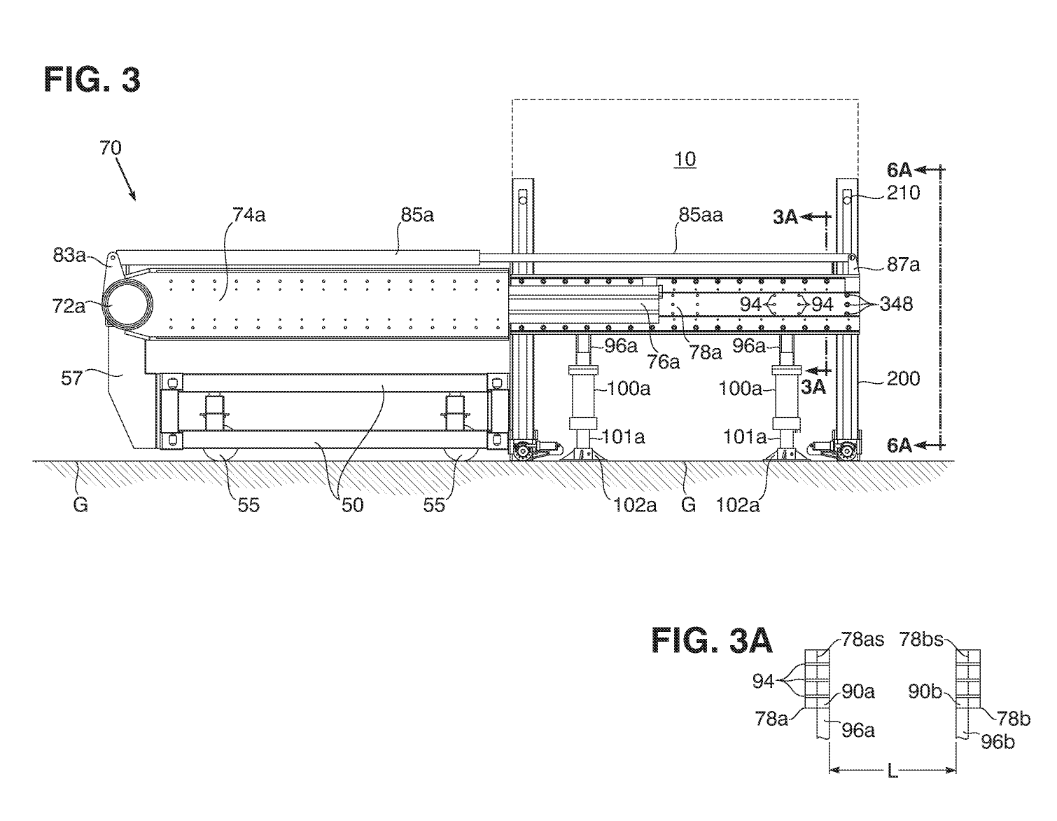

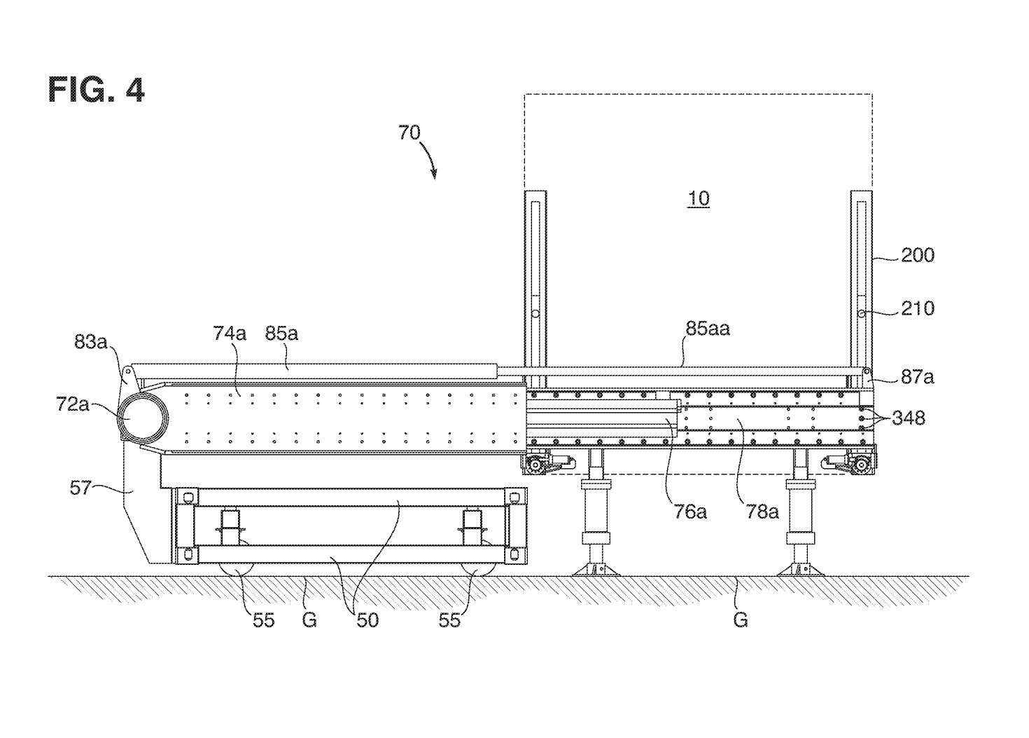

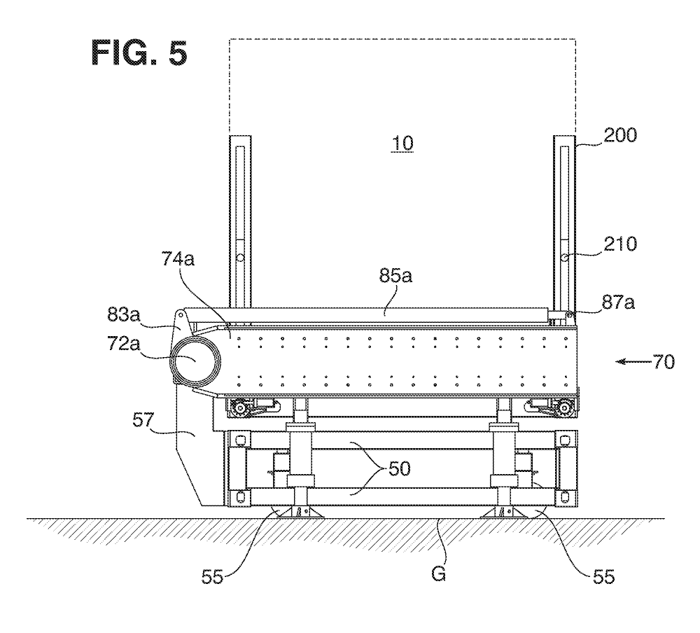

In FIG. 2, FIG. 3, FIG. 4 and FIG. 5 the shipping container 10 is shown in combination with a dolly 30. Dolly 30 includes a primary rigid support frame 50 and a capture assembly 70.

### Primary Support Frame 50

Primary support frame 50 is made of rigid steel or aluminum alloy having the capacity to support a fully loaded container 10 and the various structural members of the dolly 30. Support frame 50 has propulsion means 55 for support and maneuver of the dolly 30 on a ground support surface G. Propulsion means 55 may be roller means such as simple castoring wheels, in which case the dolly is maneuvered by pushing with an available powered vehicle such as a fork lift truck or by hand. Enhanced utility is achieved if the roller means are powered and steerable so that containers can be moved about on the ground surface G without an additional powered vehicle.

Propulsion means 55 may be powered castoring wheels. Examples include urethane polymer coated castors, rubber tires, omni-directional wheels, rotatable tracked turrets and other means of omni-directional propulsion. In the alternative to roller means, propulsion means 55 may be powered tracks. Power for propulsion is preferably provided by batteries and electric motors (not shown). Electric motors do not produce exhaust fumes and are quiet.

In one embodiment propulsion means 55 is omni-directional wheels, such as Mecanum wheels. Each Mecanum wheel is driven by its own electric motor. Independent control of each of the four electric motors is provided for full utility. Omni-directional wheels are taught in U.S. Pat. No. 3,789,947 to J. F. Blumrich, incorporated herein by reference. Mecanum wheels are taught in U.S. Pat. No. 3,876,255 for Wheels for a Course Stable Selfpropelling Vehicle Movable in any Desired Direction on the Ground or Some Other Base to B. E. Ilon incorporated herein by reference.

A secondary support member 57 joins the primary support frame 50 to the shipping container capture assembly 70. The secondary support member 57 is rigid and has the structural capacity to support the full weight of the capture assembly 70.

### Capture Assembly 70

A first jack assembly includes first jack body 72 which is horizontally oriented and fixedly attached to and vertically supported by the rigid secondary support member 57. First jack assembly also includes jack rods 72a and 72b which move reciprocally from jack body 72. Paired, parallel, opposing capture slides 74a and 74b are attached to the first jack rods 72a and 72b respectively. First jack assembly, including 72, 72a and 72b, is horizontally oriented to reciprocally draw the pair of container capture slides 74a and 74b together or to move them apart. The container capture slides 74a and 74b move cooperatively together to engage a shipping container 10. They move apart to release the shipping container 10.

Each capture slide 74a and 74b in the pair includes a generally horizontally elongated rail 76a and 76b and a sliding member 78a and 78b horizontally moveable on the rail and extendable from it. Second hydraulic jack assembly 85a and 85b is operative with jack rod 85aa and jack rod 85bb to move the sliding member horizontally between an extended position shown in FIG. 2, FIG. 3 and FIG. 4 and a retracted position shown in FIG. 5. For this purpose, the second hydraulic jack assembly 85a and 85b is attached at each end to a bracket and pin assembly. One bracket and pin assembly 83a is attached to the capture slide 74a. The other bracket and pin assembly 87a is attached to the sliding member 78a. Attachment for hydraulic jack assembly 85b is analogous with bracket and pin assembly 83b and 87b.

FIG. 3A is a sectional view taken along line 3A-3A in FIG. 3. Sliding member 78a has an attachment surface 78 as that faces the opposing sliding member 78b. Likewise, sliding member 78b has an attachment surface 78bs that faces the opposing sliding member 78a. Sliding member 78a and 78b are separated by a distance indicated by arrow L that is greater than the length of the shipping container 10 that lies between them. In a preferred embodiment, a 20-foot shipping container is lifted. That is, L is greater than about 20 feet in length.

Attachment plate 90a is in direct contact with attachment surface 78 as and is attached to sliding member 78a with bolts 94. Fourth hydraulic jack body 100a is attached to attachment plate 90a through support member 96a. Fourth hydraulic jack body 100a is supported by foot 102a through jack rod 101a. Fourth hydraulic jack includes fourth hydraulic jack body 100a, attachment plate 90a, support member 96a, jack rod 101a and foot 102a. The corresponding sliding member 78b, attachment surface 78bs, attachment plate 90b and support member 96b are shown in FIG. 3A. Foot 102b shown in FIG. 2 corresponds with foot 102a.

Secondary support member 57 joins the support frame 50 to the shipping container capture assembly 70 and is secondary support for opposing capture slides 74a and 74b. Fourth hydraulic jack 100a and 100b provide additional support for capture slides 74a and 74b in the extended position as shown in FIG. 2, FIG. 3 and FIG. 4. Fourth hydraulic jack 100a and 100b only provides support the capture slides 74a and 74b. Fourth hydraulic jack 100a and 100b does not lift or otherwise change the vertical position of capture slides 74a and 74b. The fourth hydraulic jack 100a and 100b cooperate to maintain container capture slides 74a and 74b at a common elevation above the ground surface G.

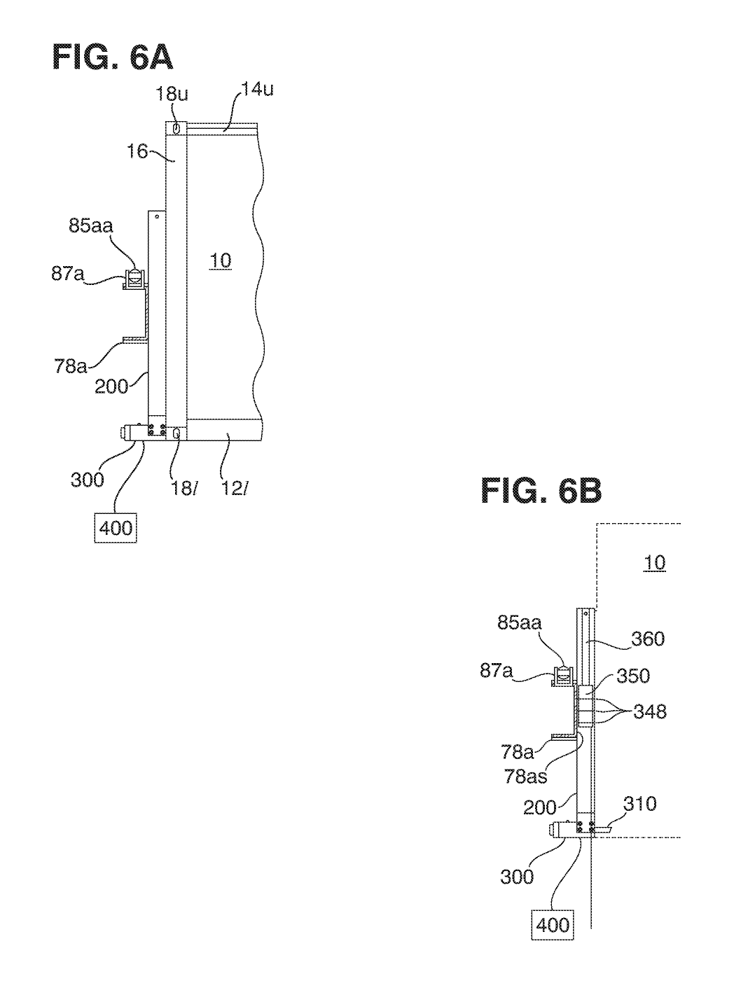

FIG. 6A is a partial side view of FIG. 3 along section 6A-6A. FIG. 6B is a view of FIG. 6A with the side of slip tube 200 removed to reveal a third hydraulic jack assembly including jack body 350 and jack rod 360 contained therein. It is important to note that slip tube 200 is not attached to sliding member 78a and is able to move up and down relative to it. Jack body 350 is attached to attachment surface 78 as on sliding member 78 with bolts 348. Jack rod 360 moves vertically up and down from jack body 350 to move slip tube 200 up and down. This relative movement is shown by indicator 210 when comparing FIG. 3 with FIG. 4. At the lower end of slip tube 200 is shipping container engagement pin assembly 300. Engagement pin assembly 300 contains engagement pin 310 in a slip collar (not shown) and actuator (not shown). Engagement pin assembly has an engagement pin 310 that extends to engage lower lifting eye 18 l of shipping container 10. Likewise hydraulically operated engagement pin assembly can retract pin 310 to disengage shipping container 10. As stated above, lower lifting eye 18 l is an engagement point in the shipping container 10 lower elongated members 12 l which is part of the container frame. The preferred engagement points are the lower lifting eyes 18 l on the shipping container ends S2 and S4.

In the usual arrangement there are four third jack assemblies. A hydraulic communication assembly 400 is in fluid communication with the four third jack assemblies and capable of moving the third jack assemblies in unison.

The dolly functions to engage eyelets at both lower ends of a shipping container. Jacks lift the container just enough to allow passage of the primary rigid support frame and wheels under the container. The container is fully supported and maneuverable. The dolly provides lifting and maneuvering of the container without counterweights or auxiliary container stabilizers. The dolly lifts and maneuvers containers on a support surface, e.g. pavement, in the absence of an overhead crane or high capacity fork lift.

The foregoing discussion discloses and describes embodiments of the invention by way of example. One skilled in the art will readily recognize from this discussion, that various changes, modifications and variations can be made therein without departing from the spirit and scope of the invention as defined in the following claims. For example, tracks and rollers are the functional equivalent of omni-directional propulsion means.

What is claimed is:

1. A dolly for lifting and maneuvering a shipping container on a support surface, comprising:
(A.) a primary rigid support frame, including support surface propulsion means, for support and maneuver of the shipping container on the support surface and having a rigid secondary support member attached to a shipping container capture assembly;
(B.) the shipping container capture assembly comprising:
(1.) a horizontally acting first hydraulic jack assembly having a body rigidly attached to the secondary support member and reciprocally acting jack rods connected to and positioned to draw together
(2.) a pair of parallel, opposing slide assemblies,
(i.) each slide assembly including:
a generally horizontally elongated rail,
a sliding member horizontally moveable on the rail and extendable therefrom, the sliding member having an attachment surface facing an opposing sliding member, and a horizontally acting second hydraulic jack assembly positioned to move the sliding member horizontally,
(ii.) a vertically acting third hydraulic jack assembly having a body attached to the attachment surface and an extendable jack rod, the jack rod moveable vertically between a lower position and an upper position,
(iii.) a shipping container engagement pin assembly attached to the jack rod, the engagement pin assembly having an engagement pin, the engagement pin moveable horizontally between a shipping container lifting point engaged position and a disengaged position.

2. The dolly of claim 1 wherein the parallel, opposing container capture slides are commonly elevated.

3. The dolly of claim 1 additionally including a fourth hydraulic jack assembly attached at a lower end to the support foot and at an upper end to a slide assembly and capable of moving from an extended position with the foot on a support surface with the jack supporting the slide assembly and a retracted position with the foot off of the support surface.

4. The dolly of claim 1 additionally including a horizontally acting engagement pin actuator attached to the engagement pin assembly and capable of moving an engagement pin horizontally.

5. The dolly of claim 1 including four third jack assemblies and additionally including a hydraulic communication assembly in fluid communication with the four third jack assemblies and capable of moving the third jack assemblies in unison.

6. The dolly of claim 1 wherein in the support frame the propulsion means comprises steerable rollers.

7. The dolly of claim 1 wherein the engagement pin engages an eyelet on a shipping container end.

8. The dolly of claim 1 wherein the vertical distance between the lower position and the upper position is about the collective vertical height of the primary rigid support frame and the support surface propulsion means.
